(19) United States
(12) Patent Application Publication
(10) Pub. No.: US 2008/0282357 A1
(43) Pub. Date: Nov. 13, 2008

(54) Method and Device for Determining Whether an Application Should Access Protected Digital Content

(76) Inventor: Jason Sharpe, Leicestershire (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/628,105

(22) PCT Filed: Jun. 4, 2004
(86) PCT No.: PCT/GB04/02393

§ 371 Date: May 5, 2008

(51) Int. Cl. G06F 1/00

(52) U.S. Cl. 726/27; 726/26

(57) ABSTRACT

A method and device for determining whether an application should access protected digital content. It is determined if a first indicator that is securely bound to the application corresponds to a second indicator that is securely bound to the protected digital content.

### CROSS REFERENCE TO RELATED APPLICATION

This application is for entry into the U.S. national phase under §371 for International Application No. PCT/GB04/002393 having an international filing date of Jun. 4, 2004, and from which priority is claimed under all applicable sections of Title 35 of the United States Code including, but not limited to, Sections 120, 363 and 365(c).

### FIELD OF THE INVENTION

Some embodiments of the invention relate to a method or device for determining whether an application should access protected digital content.

### BACKGROUND TO THE INVENTION

Digital Rights Management (DRM) is a way of protecting digital content, such as for example mobile telephone ring tones, images and videos.

The content is protected for example by only allowing the content to be previewed and not stored, by providing a free-trial period, by preventing or limiting copying of the content or by preventing or limiting onward transmission of the content.

DRM protects the owner of the content against unauthorised use, distribution or copying of the content.

The Open Mobile Alliance (OMA) has developed a DRM standard for mobile devices such as mobile cellular telephones. In this standard, the rights associated with the content are defined by a Rights Object associated with the content. This Rights Object is delivered securely to the destination and is stored securely at the destination.

This standard allows content to be delivered by ‘forward-lock’, ‘combined delivery’ or separate delivery’. Forward-lock provides a file based copy protection that prevents content from being forwarded from the destination. Combined delivery is similar to forward-lock but additional usage rights like “use only once” can be specified for the content using the Rights Object. Separate delivery provides added security by delivering the content as encrypted files and separately from the rights object. This enables superdistribution, in which DRM protected content can be virally distributed by the destination.

DRM protected content is downloaded to the mobile device e.g. by using the browser of the mobile device. It is stored in the phone's normal memory in encrypted form.

The Rights Object associated with the DRM protected content is also downloaded. It is stored in a secure portion of the mobile device's memory and cannot be tampered with by a user of the mobile device.

The Rights Object specifies the rights associated with content and how it can be used. It also includes a decryption key if the content is encrypted.

Currently only native applications to the mobile device are able to read DRM protected content. These applications are written in C and permanently stored in the memory during manufacture of the device. As these applications were stored during manufacture and cannot subsequently be modified or replaced, they can be trusted to access the DRM protected content.

However, it is now common for mobile devices to be modified or up-graded by downloading additional applications to mobile device. One way of downloading a new application is within a MIDlet suite as defined by the Mobile Information Device Profile (MIDP) version 2.0 of Java 2 Micro Edition (J2ME). A MIDlet suite comprises a Java Application Descriptor (JAD) file and a Java Archive (JAR) file. The JAD file contains information about the JAR file. The executable application resides within the JAR file. MIDP version 2.0 provides security for a certified MIDlet suite. The originator of the MIDlet suite can include a digital signature of the JAR file and a Digital Certificate.

The RSA Public Key Cryptosystem uses a matched pair of encryption and decryption keys—a Public Key (PuK) and a Private Key (PrK). Each key performs a one-way transformation upon the data. What one does the other reverses. PuK is made available by its owner, while PrK remains secret.

A private message is created by scrambling the message content with the recipient's PuK. This scrambled message can only be decoded using the recipient's PrK and therefore only by the recipient.

A digital signature is created by scrambling commonly known or derivable data using a PrK. If a person can successfully unscramble the scrambled data using a user's PuK then the data must have been originally scrambled by that user. Typically the digital signature is bound to the message content by scrambling the HASH (result of using a hash function or algorithm) of the message content using the PrK. This also means that the signature changes with each message. The recipient of the message decrypts the digital signature using PuK and compares it to the HASH of the message content. If the two match, the message has not been tampered with and its origin is verified.

However, the recipient of the message must also be sure that he is using the sender's correct public key. The public key is typically sent in a Digital Certificate along with the signed message. The Digital Certificate contains the public key (and perhaps other information) signed by a trusted third party (TTP). It includes the sender's public key (and perhaps other information) and a digital fingerprint corresponding to the HASH of the public key (and other information, if any) scrambled using the PrK of the TTP. The digital fingerprint is also known as the Certificate signature as it is the signature of the data content, including the sender's public key, in the Digital Certificate. The PuK of the TTP will be known by the recipient. The recipient can unscramble the digital fingerprint using the PuK of the TTP and compare the result with the PuK in the Digital Certificate. If they match, the identity of the sender has been verified by the TTP. This prevents one person masquerading as another. A well known TTP is the Certification Authority Verisign™

When a signed message is sent the digital certificate is included. The recipient of the message first uses the digital certificate to verify that the author's PuK included in the certificate is authentic, then uses that PuK to verify the message's signature. This way, only one Public Key, that of the TTP need be widely publicised, since then everyone else can simply transmit their Digital Certificate with their messages.

Thus a Digital Certificate, binds an identity to the public key of a public/private key pair that can be used to encrypt and sign digital information.

It is not possible at present to allow an application received in a MIDlet suite, even a certified MIDlet suite, to access DRM protected content because such access would allow a malicious application to make copies of the content and/or distribute it or would allow accidental breaches of security by a benign application. This would allow the DRM protection to be circumvented.

It would be desirable to somehow enable applications, particularly downloadable applications, to access DRM content without compromising the DRM protection of that content.

### BRIEF DESCRIPTION OF THE INVENTION

According to one embodiment of the invention there is provided a method for determining whether an application should access protected digital content, the method comprising: determining if a first indicator that is securely bound to the application corresponds to a second indicator that is securely bound to the protected digital content.

According to another embodiment of the invention there is provided a device for enabling an application to access protected digital content, comprising:

memory for storing an application, a first indicator that is securely bound to the application, protected digital content and a second indicator that is securely bound to the protected digital content; and a processor for determining if the stored first indicator corresponds to the stored second indicator.

According to another embodiment of the invention there is provided a method manufacturing a rights object comprising: creating an association with protected digital content; and including one or more indicators that specify which applications can access the associated protected digital content.

According to another embodiment of the invention there is provided a rights object associated with protected digital content comprising a data field, for controlling access of an application to the associated protected digital content, comprising an indicator that is securely bound to the application and is securely bound to a trusted third party.

### BRIEF DESCRIPTION OF THE DRAWINGS

For a better understanding of the present invention reference will now be made by way of example only to the accompanying drawings in which:

FIG. 1 is a schematic illustration of an electronic device that enabled for digital rights management; and

FIG. 2 schematically illustrates a MIDlet suite

### DETAILED DESCRIPTION OF EMBODIMENT(S) OF THE INVENTION

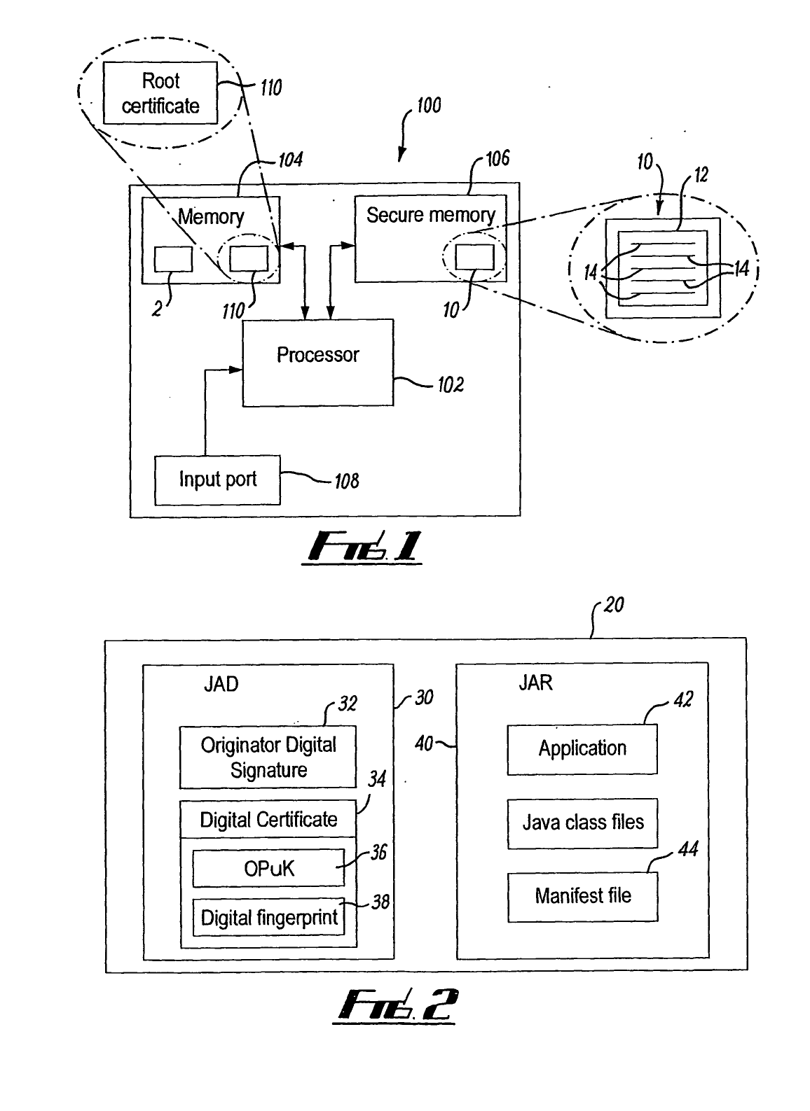

FIG. 1 schematically illustrates an electronic device 100 that is enabled for digital rights management. The electronic device 100 is, in this example a mobile hand portable electronic device, such as a mobile cellular telephone or personal digital assistant.

The device 100 comprises a processor 102, a memory 104, and a secure memory 106. The processor 102 is able to write to the memory 104 and the secure memory 106 and is able to read from the memory 104. The processor 102 is able to read from the secure memory 106 only when authorised by a DRM manager application.

The device 100 may also have an input port 108 for receiving a downloadable application. If the device is a mobile cellular telephone the input port may be a radio transceiver.

The processor 102 controls the operation of the device 100, under the control of computer program instructions loaded from the memory 104. The processor 102 provides the DRM manager application that is used to control the storage of DRM protected content and to control access to DRM protected content. The processor 102 may also provide a Java Virtual Machine for running Java applications whether native to the device 100 or downloaded to the device 100 via the input port 108, for example, within a MIDlet suite.

DRM content is delivered by combined or separate delivery to the device 100. The device 100 stores the DRM protected content 2 in the memory 104 in encrypted form and stores its associated Rights Object 10 in the secure memory 106.

Embodiments of the invention allow the owner of the content to control which applications can access its DRM protected content. This is achieved by defining a new field 12 within the Rights Object 10. This new field 12 contains permission data that controls which applications can access the DRM protected content 2. Typically this permission data will be a list of different indicators 14, where each indicator 14 identifies a trusted MIDlet or trusted class of MIDlets that is/are able to access the DRM protected content 2 associated with that Rights Object 10.

As the permission data 12 is within the Rights Object 10 it is non-editable and secure from undetectable modification. The permission data 12 cannot be tampered with or altered by a user of the device 100.

Each indicator 14 in the Rights Object 10 is typically used to indicate a MIDlet application that is trusted to access the DRM protected content 2 associated with that Rights Object 10. This trust is maintained by bindings between the MIDlet, the indicator 14 and the key pair of a trusted third party (TTP).

The binding between the indicator 14 and the MIDlet can be used to detect modification of the indicator 14 and modifcation of the application (MIDlet JAR). The binding between the indicator 14 and the TTP can be used to verify that the indicator 14 is being used only by the originator who is authorised to use this indicator 14.

A typical MiDlet suite 20 is illustrated in FIG. 2. The MIDlet suite comprises a Java Application Descriptor file (JAD) 30 and a Java Archive (JAR) file 40. The JAD file 30 contains information about the JAR file 40. An executable application 42 resides within the JAR 40. The JAR 40 also contains the Java class files and a manifest file 44 describing the contents of the JAR 40.

Java 2 Micro Edition (J2ME) and its Mobile Information Device Profile (MIDP) version 2.0 provides security for a MIDlet suite 20 using a public/private key pair and a Digital Certificate from a trustred third party (TTP) validating the public key. The public/private key pair consists of an originator public key (OPuK) and an originator private key (OPrK) which belong to the originator of the Midlet suite 20.

The originator digitally signs the JAR 40 using the originator private key (OPrK) and the resultant originator digital signature (ODS) 32 is added to the JAD file 30. The originator digital signature 32, the originator's key pair and the content of the JAR 40 are bound together. The originator digital signature 32 is calculated by taking the HASH of the JAR 40 and then scrambling the result using the originator's private key (OPrK).

The originator then adds a Digital Certificate (DC) 34 supplied by the trusted third party (TTP) to the JAD file 30. The DC 34 contains the originator's public key (OPuK) 36 and a digital fingerprint (DF) 38. The digital fingerprint 38, the key pair of the TTP and the originator's public key (OPuK) 36 are bound together. The digital fingerprint 38 is calculated by taking the HASH of the originator's public key (OPuK) 36 and scrambling the result using the private key of the TTP.

The Digital Certificate 34 allows a recipient of the MIDlet suite 20 to authenticate its originator and the originator digital signature (ODS) 32 allows the recipient to verify the content of the JAR 40.

A MiDlet suite 20 that has a JAD 30 comprising the originator's digital signature (ODS) 32 for the JAR 40 and a Digital Certificate 34 is a certified MiDlet suite.

The certified MIDlet suite 20 is then distributed.

The recipient device 100 stores a root certificate 110 of the TTP, that includes the public key of the TTP.

When the Midlet suite 20 is first received, the recipient device 100 verifies the source of the MIDlet i.e. verifies the originator's identity using the digital fingerprint 38 from the Digital Certificate 34 within the JAD 30. The recipient device 100 unscrambles the digital fingerprint 38 using the TTP public key obtained from the root certificate 110 and compares the result to the HASH of the originator's public key (OPuK) 36 obtained from the Digital Certificate 34. A match verifies the identity of the originator and that the originator's public key (OPuK) 36 is valid.

The recipient device 100 then verifies the JAR 40. The recipient device unscrambles the originator's digital signature (ODS) 32 using the verified originator's public key (OPuK) 36 obtained from the Digital Certificate 34 and compares the result to the HASH of the JAR 40. A match verifies the JAR 40 does originate from the verified originator and that the JAR 40 is valid.

Subsequently, when the MIDlet application 42 within the JAR 40 is run and attempts to access DRM protected content 2, a DRM manager application controls access.

Instead of automatically preventing access, the DRM manager determines whether the DRM protected content 2 which is to be accessed has an associated rights object 10 that allows such access.

The DRM manager reads the permission data 12 from the associated Rights Object 10. The DRM manager determines if any of the indicators 14 within the permission data 12 are bound to the MIDlet application 42 and to a TTP.

If the indicators 14 in the Digital Rights Object corresponds to a specified field in the JAR of the certified MIDlet, then such a field is bound to the MIDlet application 42 via the originator's digital signature 32 but it is not bound to a TTP. It may therefore be possible to use a false field in the JAR 40. Therefore if the indicator is to correspond to a field in the JAR 40 there needs to be an additional mechanism for verifying that only an authorised field is used. That is, the field should somehow be bound to the TTP.

This may be achieved, for example, by inserting a Digital Certificate into the JAR 40 and using the public key within it or the fingerprint within it as the indicator.

It may also be achieved by adding identifying data and signing that data using the originator's private key. The public key from the JAD 30, which has been verified using the Digital Certificate in the JAD, may be used to verify the identifying data.

However, it is preferable to re-use a field that already exist within the JAD as the indicator 14 in the rights object 10 rather than inserting a new field into the JAR 40.

For example, it is possible for the indicator 14 to correspond to an originator's digital signature 32 from the JAD 30. In this case the permission data 12 is a list of originator digital signatures 32. Each originator digital signature 32 is a HASH of a JAR 40, which is then scrambled using an originator's private key (OPrK). In this implementation, initially the DRM manager application compares the list of indicators 14 in the rights object 10 with the originator's digital signature in the JAD 30 associated with the MIDlet application 42 trying to access the DRM protected content 2.

If a match is found, then the binding between the indicator 14, application 42 and TTP may be verified by first unscrambling the digital fingerprint 38, from the Digital Certificate 34, using the public key of the TTP and checking that the result includes the originator's public key (OPuK) 36 from the Digital Certificate 34, and then unscrambling the indicator 14 using the originator's public key (OPuK) 36 from the Digital Certificate 34 and checking that the result corresponds to the HASH of the JAR 40 containing the application 42.

Alternatively, if the MIDlet is stored securely and is protected from modification after it was verified on download, then the binding between the indicator 14, application 42 and TTP has already been verified and could not have changed since verification.

A problem with using the digital signature 32 as the indicator 14 is that it will change as the JAR is modified, even minutely by the originator. Therefore every JAR version will need its own different indicator.

As another example, it is possible for the indicator 14 to correspond to the originator's public key (OPuK) 36 from the Digital Certificate 34 in the JAD 30. In this case the permission data 12 is a list of OPuKs 36. In this implementation, initially the DRM Manager application compares the list of indicators 14 from the rights object 10 with the originator's public key (OPuK) 36 in the Digital Certificate 34 in the JAD 30.

If a match is found, then the binding between the indicator 14, application 42 and TTP may be verified by first unscrambling the digital fingerprint 38, from the Digital Certificate 34, using the public key of the TTP and checking that the result includes the indicator 14, and then unscrambling the originator's digital signature 32 using the indicator 14 and checking that the result corresponds to the HASH of the JAR 40 containing the MIDlet application 42.

Alternatively, if the MIDlet is stored securely and is protected from modification after it was verified on download, then the binding between the indicator 14, application 42 has already been verified and could not have changed.

This indicator (OPuK) does not have to change when the JAR varies and can be used with different JARs. The content provider trusts the verified originator to only include authorised applications within such JARs.

As another example, it is also possible for the indicator 14 to correspond to the digital fingerprint 38 from the Digital Certificate 34 in the JAD 30. In this case the permisssion data 12 is a list of digital fingerprints 38. Each digital fingerprint 38 is an originator's public key (OPuK) 36 (and other data) scrambled using the private key of a trusted third party (TTP). In this implementation, initially the DRM Manager application compares a list of indicators with the digital fingerprint 38 in the Digital Certificate 34 in the JAD 30 associated with the subject MIDlet application 42.

If a match is found, then the binding between the indicator 14, application 42 and TTP may be verified by first unscrambling the indicator 14, using the public key of the TTP and checking that the result includes the originator's public key (OPuK) 36 from the Digital Certificate 34, and then unscrambling the originator's digital signature 32 using the originator's public key 36 from the Digital Certificate 34 and checking that the result corresponds to the HASH of the JAR 40 containing the application 42.

Alternatively, if the MIDlet is stored securely and is protected from modification after it was verified on download, then the binding between the indicator 14, application 42 and TTP has already been verified and could not have changed.

This indicator (digital fingerprint) does not have to change when the JAR varies and can be used with different JARs. The content provider trusts the verified originator to only include authorised application within such JARs.

In the circumstances where the indicators 14 in the permission data 12 in the rights object 10 correspond to an originator's public key 36 or a digital fingerprint, it may be desirable to specify an additional indicator that restricts access to a specific MIDlet or a specific group of MIDlets. This may be achieved by adding the additional indicator to the permission data 12 in the rights object 10 and to the manifest file 44 in the JAR 40. The originator of the MIDlet suite is trusted to provide such an additional indicator only to the MIDlet suites that should be able to access DRM protected content and it is witheld from those MIDlet suites that should not access DRM protected content. The additional indicator's location in the JAR 40 prevents it being tampered with. In this implementation, after the DRM Manager application has determined that the indicator 14 in the JAD 30, which is associated with the MIDlet application 42 attempting to access DRM protected content 2, is the same as the indicator in the permission data 12 of the rights object 10 associated with the DRM protected content that is to be accessed, and has verified the binding between the indicator 14, the MIDlet application 42 and a TTP, then the DRM Manager application additionally checks that the additional indicator from the permission data 12 of the rights object is the same as the additional indicator from the manifest 44 of the verified JAR 40.

Although embodiments of the present invention have been described in the preceding paragraphs with reference to various examples, it should be appreciated that modifications to the examples given can be made without departing from the scope of the invention as claimed. For example, when reference is made to the originator public key as an entity in the Digital Certificate or as a result of unscrambling the digital fingerprint, it refers to the originator's public key and perhaps also other data. When reference is made to the originator public key as an entity used for verifying the originator's digital signature it refers to the originator's public key only. A Rights Object is one means that is suitable for controlling access to protected content.

Verisign/Thwate are examples of one type of TTP (top level certificate issuer) that enables trust to be established with another third party (e.g. application provider) and become a TTP.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A method for determining whether an application should access protected digital content, the method comprising:
determining if a first indicator that is securely bound to the application corresponds to a second indicator that is securely bound to the protected digital content.

2. The method as claimed in claim 1, wherein the first indicator is securely bound to the application via a digital signature.

3. The method as claimed in claim 1, wherein the second indicator is securely bound to the protected digital content by its presence in a rights object associated with the protected digital content.

4. The method as claimed in claim 1, further comprising:
verifying that the first indicator is bound to the application.

5. The method as claimed in claim 4, wherein the step of verifying comprises:
a scrambling operation involving the first indicator; and
a comparison operation involving the hash of data comprising the application.

6. The method as claimed in claim 1, wherein the first indicator is additionally securely bound to a trusted third party.

7. The method as claimed in claim 6, wherein the secure binding of the first indicator to a trusted third party involves a digital certificate.

8. The method as claimed in any claim 1, further comprising:
verifying that the first indicator is bound to a trusted third party.

9. The method as claimed in claim 8, wherein the step of verifying comprises:
a scrambling operation involving the first indicator; and
a comparison operation involving the hash of a public key.

10. The method as claimed in claim 1, wherein the first indicator is a digital signature of data comprising the application.

11. The method as claimed in claim 10, wherein the first indicator is a digital signature of a java archive file.

12. The method as claimed in claim 1, wherein the first indicator is a public key from a digital certificate.

13. The method as claimed in claim 12, wherein the public key is the public key of an originator of the application.

14. The method as claimed in claim 12, wherein the digital certificate is provided in a java application descriptor of a certified MIDlet suite comprising the application.

15. The method as claimed in claim 1, wherein the indicator is a digital signature of a digital certificate.

16. The method as claimed in claim 15, wherein the digital certificate is provided in a java application descriptor of a certified MIDlet suite comprising the application.

17. The method as claimed in claim 1, further comprising determining if a first additional indicator securely bound to the application corresponds to a second additional indicator securely bound to the protected digital content.

18. The method as claimed in claim 17, wherein the first additional indicator is securely bound to the application by its presence in a java archive file comprising the application.

19. The method as claimed in claim 17, wherein the second additional indicator is securely bound to the protected digital content by its presence in a rights object associated with the protected digital content.

20. A device for enabling an application to access protected digital content, comprising:
a memory for storing an application, a first indicator that is securely bound to the application, protected digital content and a second indicator that is securely bound to the protected digital content; and
a processor for determining if the stored first indicator corresponds to the stored second indicator.

21. The device as claimed in claim 20, wherein the processor is operable to determine if the stored first indicator corresponds to the stored second indicator when the stored application attempts to access the stored protected digital content.

22. The device as claimed in claim 20, wherein the memory comprises a memory and a secure memory, wherein the second indicator is stored in the secure memory.

23. The device as claimed in claim 22, wherein the second indicator is stored in a rights object associated with the protected digital content and stored in the secure memory.

24. The device as claimed in claim 20, wherein the processor is operable to verify that the first indicator is bound to the application.

25. The device as claimed in claim 20, wherein the processor is operable to verify that the first indicator is bound to a trusted third party.

26. The device as claimed in claim 20, wherein the processor is operable to verify that the second indicator corresponds to a digital signature of data comprising the application.

27. The device as claimed in claim 26, wherein the processor is operable to verify that the second indicator corresponds to a digital signature of a java archive file comprising the application.

28. The device as claimed in claim 20, wherein the processor is operable to verify that the second indicator corresponds to a public key from a digital certificate.

29. The device as claimed in claim 28, wherein the digital certificate is provided by a java application descriptor of a certified MIDlet suite, comprising the application, stored in the memory means.

30. The device as claimed in claim 20, wherein the processor is operable to verify that the second indicator corresponds to a digital signature of a digital certificate.

31. The device as claimed in claim 30, wherein the digital certificate is provided by a java application descriptor of a certified MIDlet suite, comprising the application, stored in the memory means.

32. The device as claimed in claim 1, wherein the processor is operable to determine if an additional first indicator bound to the application corresponds to an additional second indicator bound to the protected digital content.

33. A method for manufacturing a rights object comprising:
creating an association with protected digital content; and
including one or more indicators that specify which applications can access the associated protected digital content.

34. The method as claimed in claim 33, wherein each indicator is securely bound to an application and is securely bound to a trusted third party.

35. A rights object associated with protected digital content comprising
a data field, for controlling access of an application to the associated protected digital content, and an indicator that is securely bound to the application and is securely bound to a trusted third party.

36. A memory storing a rights object as claimed in claim 35.

37. A data carrier storing a rights object as claimed in claim 35.

38. (canceled)
